(19) United States
(12) Patent Application Publication
(10) Pub. No.: US 2006/0136924 A1
(43) Pub. Date: Jun. 22, 2006

(54) Workflow process management system including shadow process instances

(76) Inventors: Shazia W. Sadiq, Pullenvale (AU); Maria E. Orlowska, Brookfield (AU); Wasim Sadiq, Pullenvale (AU); Karsten A. Schulz, Middle Park (AU)

Correspondence Address: SCHWEGMAN, LUNDBERG, WOESSNER & KLUTH, P.A., P.O. BOX 2938, MINNEAPOLIS, MN, 55402, US

(21) Appl. No.: 11/019,481

(22) Filed: Dec. 21, 2004

(51) Int. Cl. G06F 9/46

(52) U.S. Cl. 718/104

(57) ABSTRACT

A workflow management system, computer, and method has associated with it one or more shadow process instances. The system invokes these shadow process instances through internal logic, or at the behest of a user. Each such instance can be identified through unique parameters. The shadow process instances can be grouped, ungrouped, and/or regrouped, and this injects into the system a flexibility to adapt to many different organizational structures.

The present application relates to business process management, and in particular, workflow management methods and systems.

### BACKGROUND

Technologies that support business process management (BPM) provide businesses with the ability to effectively utilize, control, and monitor their resources. Workflow technologies, as one aspect of business process management, provide control and monitoring functions for entities such as business oriented software processes and systems. For example, workflow technologies support process execution by monitoring the order of activities, the start time of the activities, and the performers of the activities. In one particular workflow technology, Workflow Management Systems (WFMS) clearly separate business process logic from component applications that are involved in process execution. One result of this separation of business process logic and component applications is a more conducive environment for application integration.

Workflows in workflow management systems are typically characterized through process models, where individual cases within these process models constitute instances of the workflow. A process model typically has several activities, and each activity has detailed semantics that are defined through its properties such as input and output data, temporal constraints, resource requirements, and transactional properties. The specification of the properties of a given activity identifies the activity type.

An instance of a process has one instance of each activity type defined in the process model. Instances of the activities depict the execution of the workflow. Each activity instance is governed by a finite state machine that characterizes the behavior of the activity through its observable states (e.g., available, commenced, completed, and terminated). The schema of workflow control data can therefore be summarized in that 1) a process has many activities, 2) a process has many instances, and 3) an activity has many instances, but only one (or zero) instance in a given process instance.

One problem associated with business process management and workflow management technologies is their limited ability to deal with dynamic changes and business exceptions. That is, while workflow technology, up to this point in time, has delivered a great deal of productivity improvements, the improvements have been mainly for pre-defined static and repetitive business processes. Another problem with workflows is that workflow modeling languages provide limited modeling constructs. Moreover, in some cases, there is a contradiction and tension between the preferred work practice that is to be automated in a system and the underlying principles of workflow systems. Consequently, process logic cannot be appropriately mapped to the workflow model. This further results in compromised process models and subsequent compromised process goals. In short, current business process modeling approaches are not able to handle at least some typical scenarios in current business environments.

### SUMMARY OF EMBODIMENTS

An embodiment of the invention encompasses systems and methods for business process management, and more specifically, systems and methods for workflow process management. In an embodiment, activities or instances in a process model are grouped, ungrouped, and regrouped to suit the particular needs of an organization. These groupings, ungroupings, and regroupings create shadow process instances. The shadow process instances themselves can then be grouped, ungrouped, and regrouped to suit the processing needs of the organization. These processes can be repeated to any extent necessary to correctly model the organization.

### BRIEF DESCRIPTION OF THE DRAWINGS

FIGS. 1a, 1b, and 1c illustrate embodiments of workflow process management systems of the invention.

FIG. 2 illustrates an activity signature of an embodiment of the invention.

FIG. 3 illustrates an ungrouping function that may be used in connection with an embodiment of the invention.

FIG. 4 illustrates a process of an embodiment of the invention that changes one activity ID into another activity ID.

FIG. 5 illustrates a regrouping function that may be used in connection with the invention.

FIG. 6 illustrates the regrouped activities of FIG. 5 in isolation.

FIG. 7 illustrates an ungrouping function that may be used in connection with the invention.

FIG. 8 illustrates a process of an embodiment of the invention that changes one activity ID into another activity ID.

FIG. 9 illustrates a process of an embodiment of the invention involving the grouping, ungrouping, and regrouping of activities.

FIG. 10 illustrates a computer system upon which an embodiment of the invention may operate.

FIG. 11 illustrates an architecture upon which an embodiment of the invention may operate.

FIG. 12 illustrates an application and database structure for the architecture of FIG. 11.

### DETAILED DESCRIPTION

To address the shortcomings of current state-based business process management and workflow management systems, an embodiment of the invention redefines the notion of a process instance. At the present time, the notion of an instance in workflow systems is well defined in the art. However, this notion can be too restrictive in certain scenarios that are found in many domains. This restrictiveness forces process models to be constructed in a format that contradicts the manner in which work is actually performed in an organization. Therefore, in this embodiment, an activity is not limited to a single execution, or activity instance, within a given process instance.

As an example, in many situations there is a need to manage activity instances at multiple levels. For instance, in a business order environment, an approval function may be applied at the purchase request level (wherein a purchase request may contain many items), while a cancellation function can be applied at the item level. To handle this different scope of operation, embodiments of the invention create and work with multiple process views. That is, embodiments of the invention can apply some functions to higher levels in the process model (referred to as compound level activity instances) and apply other functions to lower levels in the process model (referred to as atomic level activity instances). The particular application that is made depends on the business requirements of the situation—embodiments of the invention adjust to the business situation at hand. These multiple process views that may be created and handled by embodiments of the invention are alternative process views or instances and may also be referred to as shadow process instances (SPI). Further to the example, in an order processing environment, a merchant may normally organize its purchase orders via customer, and then handle the items requested, quantities requested, quantities shipped, and quantities paid for, in isolation for that customer. However, in embodiments of the invention, different items from one or more purchase requests may be ungrouped into newly created purchase orders. Thereafter, items from several of these newly created purchase orders may be regrouped into a new different purchase order.

Therefore, in one or more embodiments of the invention, for a particular process model, there can be multiple shadow process (alternative process) instances. These shadow process instances are created by the grouping, ungrouping, and/or regrouping of activity instances as the activity instances are created. Consequently, there are multiple shadow process instances in existence at any particular time, and a user may choose which instance(s) to work with, and/or a system may determine the pertinent instance(s) to work with. Referring back to the order processing example, shadow process instances may be created that include a single item from a purchase request, all items in a shipment order, or all invoices for a given customer. And as will be explained in detail infra, embodiments of the invention maintain a consistent state of progress for each shadow process instance and the entire order process (through an activity state of the instances).

In one or more embodiments, the invention implements advanced processing requirements such as the ones identified above by adding extensions to current state-based workflow management systems. Specifically, the functions of group, ungroup and regroup are implemented as extensions to a workflow management system.

Referring back to the concept of atomic and compound activities, an activity of type t is an atomic activity if it cannot be expressed by a set of activities also of type t, but with different content. An activity of type t is a compound activity if it can be expressed (or executed) by a set of atomic activities all of type t. A compound activity can be normalized by expressing it as a set of atomic activities.

In an embodiment of the invention, each instance in a process model has several identifiers and properties. Specifically, there are an activity ID, a process instance ID, an activity instance ID, a group instance ID, and an activity state. The manner in which these identifiers work together to uniquely identify compound and atomic activities will become apparent in the following paragraphs.

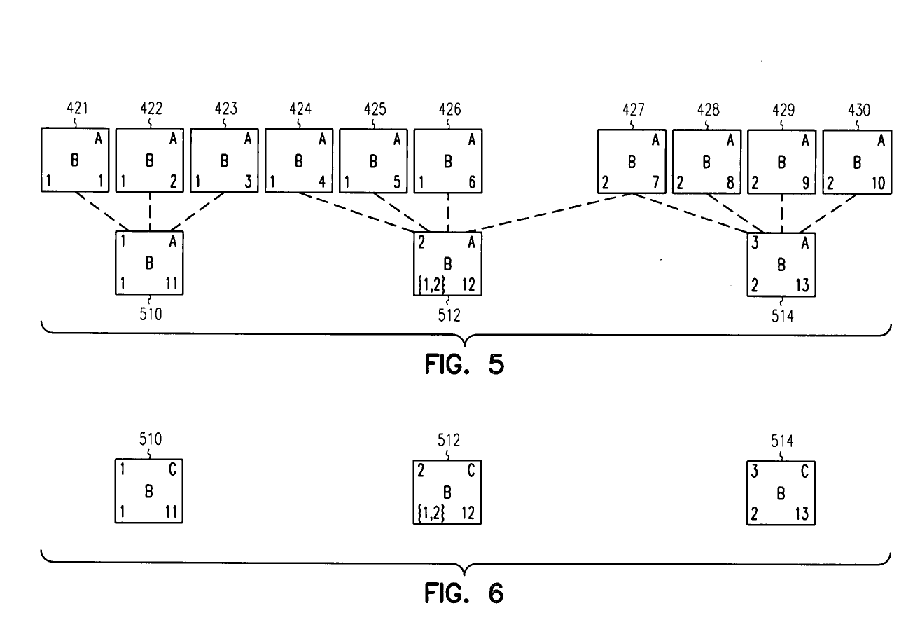

In an embodiment of the invention, a group function is applied to a set of activity instances in which the activity level is atomic and the activity state is “available”. (See e.g., FIG. 5, in which activity instance IDs 1, 2, and 3 in blocks 421, 422, and 423 are grouped into instance 510 with group instance ID 1). Stated as an expression,
Activity_Level(tᵢ)=Atomic and
Activity_State(tᵢ)=Available;
where tᵢ represents a set of activity instances, and i represents individual instance numbers (i.e., 1, 2, 3 . . . . n). Therefore, the group function generates an activity instance tₖ of the same activity type or ID as the atomic activities that constitute it (i.e., tᵢ). The generated activity instance tₖ has an activity state that is available just like the original atomic activity (i.e., Activity_State(tₖ)=Available). However, the generated activity instance tₖ has collated content (e.g., all invoices for a given customer). Thus, in a short hand notation,
Group({tᵢ})→tₖ.

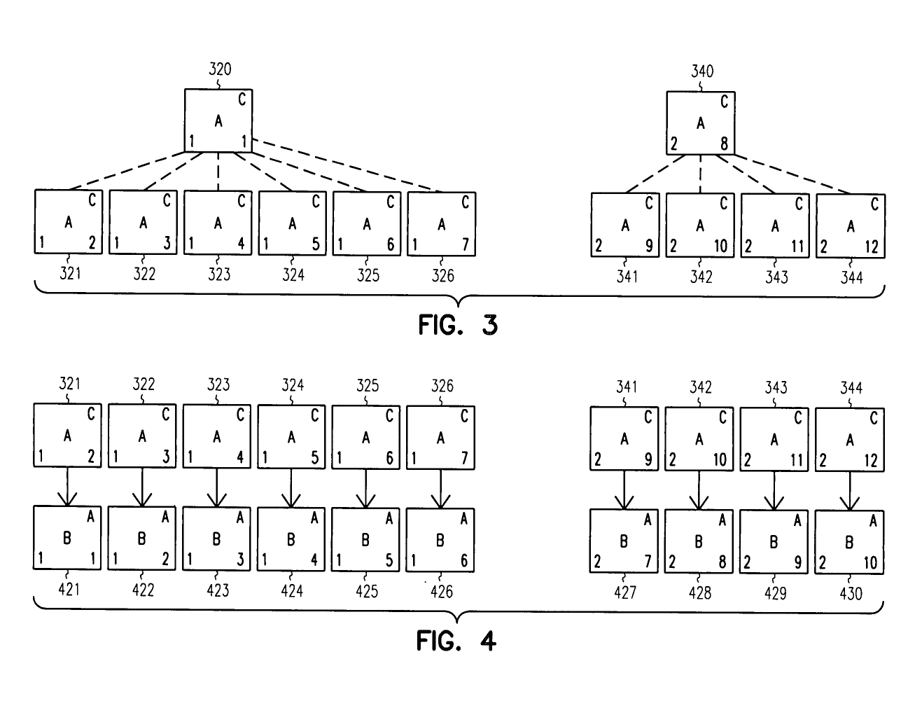

In another embodiment of the invention, an ungroup function is applied to an activity instance tₖ whose activity level is compound and activity state is completed. (See e.g., FIG. 3, in which instance 320 is ungrouped into instances 321, 322, 323, 324, 325 and 326). In an expressional notation,
Activity_Level(tₖ)=Compound, and
Activity_State(tₖ)=Completed;
where tₖ is an activity instance with instance number k. As such the ungroup function generates a set of activity instances tᵢ where i represents the instance number, and all activity instances tᵢ are of the same activity type or ID as the compound activity (i.e., tₖ) from which it was generated. And like the compound activity from which it was generated, each instance in this generated set of activity instances has an activity state of “Completed.” The content of each activity instance in the set of activity instances however is normalized (i.e., it is an atomic activity). Thus, in an expressional form,
Ungroup tₖ=→({tᵢ}).

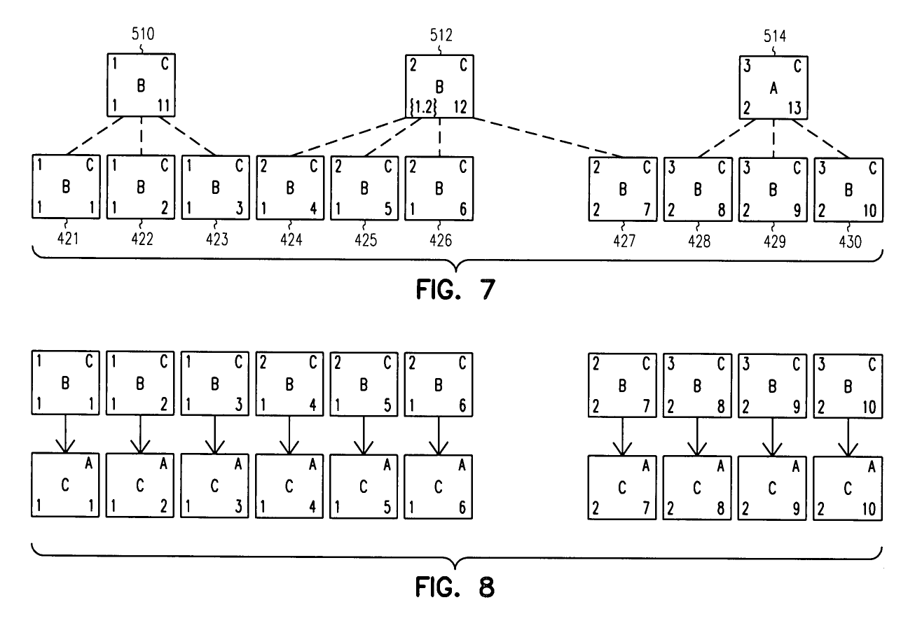

In these embodiments, both the group function and the ungroup function deal with activity instances independent of the process instances. That is, the activity instances that are grouped are grouped independent of the process instances from which they originate (See e.g., FIG. 5, in which instances 424, 425, and 426 with process ID 1, and instance 427 with process instance ID 2, are grouped into instance 512 with group ID 2 and process ID {1,2}), and the activity instances that are ungrouped can be populated into multiple process instances (See e.g., FIG. 7, in which instance 512 is ungrouped into instances 424, 425 and 426 with process ID 1, and instance 427 with process ID 2).

In an embodiment, the invention manages the activity signature (i.e. activity ID, process instance ID, activity instance ID, group instance ID, and activity state) as the activities get grouped, ungrouped, and/or regrouped. Specifically, the invention provides extensions to a work flow management system's Work List Handler and Workflow Control Data processes.

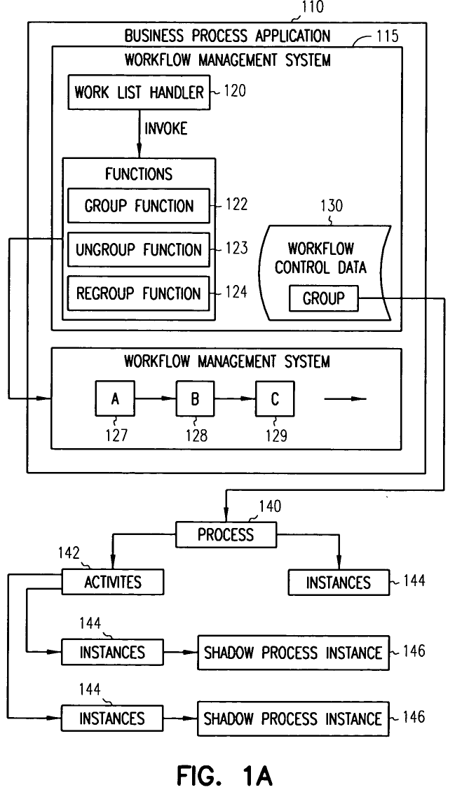

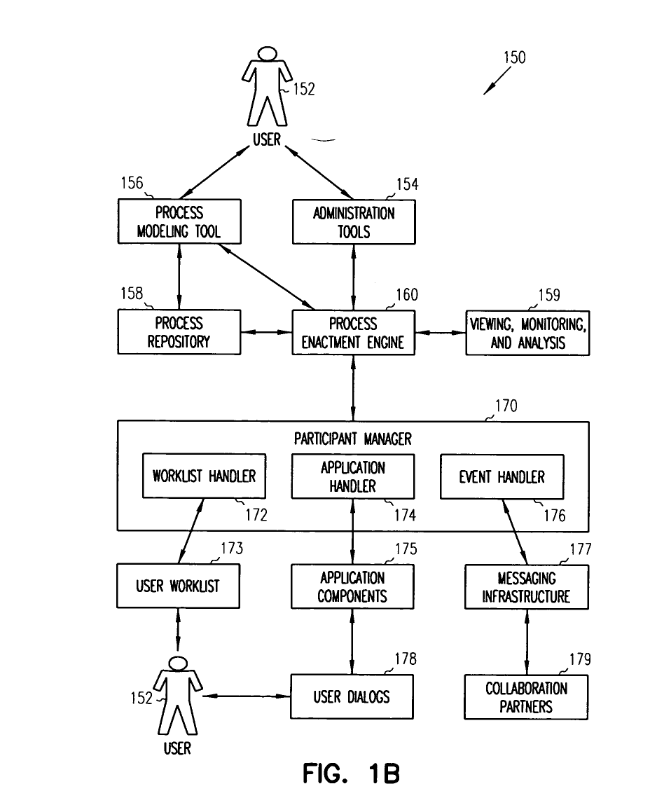

In an embodiment of the invention, as illustrated in FIG. 1a, a workflow management system 115 of a business process application 110 has a Work List Handler 120 that is a front end component for providing grouping, ungrouping, and regrouping functions (122, 123, 124). The Work List Handler 120 determines when the grouping, ungrouping, and regrouping functions are invoked, and the data that are required to performs these functions. Specifically, the Work List Handler 120 provides for the auto-invocation or user-invocation of these functions at designated activities (e.g., 127, 128, 129, 142) within the process model. The activities that are initially grouped or ungrouped may be referred to as primary process activities. FIG. 1b illustrates another embodiment of a Business Process Management architecture 150 that can be used in connection with the present invention. A user 152 has access to administration tools 154 and process modeling tools 156. A process enactment engine 160 has access to these two sets of tools, and also a process repository 158. The user 152 can view, monitor and analyze the process enactment (159). Enacted processes are deployed into a participant manager 170, which has a worklist handler 172, an application handler 174, and an event handler 176. The worklist handler 172 communicates with a user worklist 173, the application handler 174 oversees application components 175, and the event handler 176 manages a messaging infrastructure 177. A user 152 uses the application components 175 of the system 150 by a user dialog interface 178. Non-system users 179 can interact with the system 150 through the messaging infrastructure 177. FIG. 1c illustrates an embodiment in which certain features of FIG. 1b are highlighted. In particular, FIG. 1c illustrates in more detail that the process enactment engine 160 has workflow control data 162 and scheduler 164. The process enactment engine communicates with the worklist handler 172, which, in addition to its core functions (172b), handles the grouping and ungrouping functions (172a). The user 152 is able to interact with the system through the user dialogs 178, the application components 175, and the user worklist 173.

More specifically, in an embodiment, activity ungrouping takes place when a designated compound activity reaches the “Complete” state. (See FIG. 3). This is generally done through an auto-invoke, since the determination that a compound activity is completed is readily determined by the system. This then results in the ungrouping, or creation, of multiple shadow process instances in which the ungrouped activity is presented at an atomic level. The activity state of the compound and all its constituent atomic activities remains the same, i.e. “Complete.” In this embodiment, once the atomic activities are created, process control flow is based on the atomic activities only. That is, the corresponding compound activity from which the atomic activities where born does not engage in process control flow from that point on.

In an embodiment having the feature of grouping (and/or regrouping), such grouping may take place when a designated activity is put into the “Available” state. Like the ungrouping function, the grouping function can either be auto-invoked or user-invoked. In the grouping process, the group should maintain the constituent process instance ID references. Upon completion of the grouping activity, all constituent activity instances may be put into a “Complete” state.

In one embodiment, all available activities of a given group are grouped. An example of this from the order processing context is marking all available items and grouping them. In another embodiment, a user is given control over the groupings, and for example can construct such groupings as all purchase requests from the same customer, or invoices prepared by a given performer.

As to the data that is required for these functions, grouping may be based on a variety of criteria such as activity state data, activity performer data, and the activity content. In one embodiment, the ungrouping function is largely automated provided that the criterion is known—for example, ungrouping the items of a purchase request, or ungrouping the units (i.e., the quantity) of the items of a purchase request. While grouping may be similarly automated, in one embodiment the grouping function is user controlled. Whatever embodiment, automated or user-controlled, is installed, the system provides access to the activity related data for further use and/or computations.

In an embodiment, while the Work List Handler 120 provides the front end for the invocation and specification of grouping and ungrouping functions, the Workflow Control Data process 130 supports the specification at the back end of the system. One or more embodiments of the invention extend the Workflow Control Data process to provide for the advanced requirements of grouping, ungrouping and/or regrouping. The extension allows an activity to be tracked through the various groupings, ungroupings, and regroupings that the activity is exposed to.

Specifically, in this embodiment, the Workflow Control Data process is extended to incorporate the concept of a group. While this extension is relatively straightforward and simple, in the context of the invention it is powerful and effectively maintains the activity signature throughout the process. The concept of a group here involves, as illustrated in FIG. 1a, a process 140 that has many activities 142, and a process that has many instances 144. This however is extended such that an activity may have many (or zero) instances in a given process instance.

In another embodiment, the notion of a group instance is utilized. A group instance represents a dynamically defined group of activity instances. Consequently, in this embodiment, an activity instance belongs to only one group instance, but a group instance may have multiple activity instances. Moreover, a process instance may have multiple group instances, and a group instance may belong to multiple process instances.

The following example illustrates the extended function of the Work List Handler 120 and the Workflow Control Data 130 processes of a workflow management system 115 as illustrated in general in FIG. 1a.

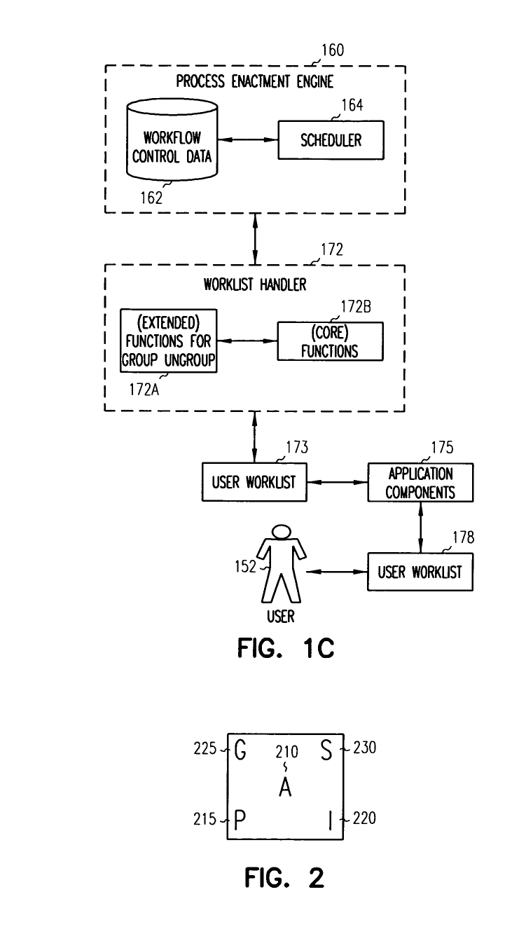

Each activity 127, 128, and 129 has associated with it data that specifically identifies the activity, instances of the activity, and shadow process instances 146 generated from the activity instances. This data makes up the activity signature, and is illustrated in graphic form in FIG. 2. The activity illustrated in FIG. 2 has an activity ID A at 210, a process instance ID P at 215, an activity instance ID I at 220, a group instance ID G at 225, and an activity state S (e.g., “C” for complete, “A” for available) at 230.

FIG. 3 illustrates the creation of two instances 320 and 340 of a process. As seen from FIG. 3, the two instances 320 and 340 are two instances of activity A, identified by activity instance IDs (FIG. 2, No. 220) 1 and 8 respectively. The collated content associated with activity instance ID 1 consists of six atomic elements 321, 322, 323, 324, 325, and 326 (activity instance IDs 2, 3, 4, 5, 6, 7), and the collated content associated with activity instance ID 8 consists of four atomic elements 341, 342, 343, and 344 (activity instance IDs 9, 10, 11, 12).

FIG. 4 illustrates that when activity instance ID 1 and activity instance ID 8 reach the “Complete” state, the ungroup function is auto-invoked, resulting in the generation of six and four atomic activity references respectively. According to the process control flow, each atomic activity 321, 322, 323, 324, 325, 326, 341, 342, 343, and 344 (activity instance IDs 2, 3, 4, 5, 6, 7, 9, 10, 11, 12) schedules the next activity 421, 422, 423, 424, 425, 426, 427, 428, 429, and 430 (activity ID B, activity IDs 1, 2, 3, 4, 5, 6, 7, 8, 9, and 10). Consequently, ten activities identified by activity ID B are created as illustrated in FIG. 4. It is noteworthy that the process ID for the atomic activity(ies) is(are) the same as that of the compound activity. So, in the case of compound activities, the atomic counterparts of these compound activities may be regrouped with atomic collections from other process instances. (For example, in FIG. 5, instance 427, with process instance ID 2, is regrouped with instance 424, 425, and 426 into instance 512 having process instance ID {1,2}).

FIG. 5 continues the present example by illustrating the grouping function as applied to the activities identified as activity ID B (421, 422, 423, 424, 425, 426, 427, 428, 429, and 430; activity instance IDs 1, 2, 3, 4, 5, 6, 7, 8, 9, 10). Grouping is usually defined in accordance with application requirements, and as explained above, can be auto-invoked or user-invoked. As also mentioned above, in an embodiment, the grouping function is provided through an extended interface of the Work List Handler. Referring to FIG. 5, the grouping function in this example generates group instance IDs 1, 2 and 3 (activity instance IDs 11, 12, and 13) at instances 510, 512, and 514, with group instance ID 1 (510) being generated from activity instance IDs 1, 2, and 3 (421, 422, and 423), group instance ID 2 (512) being generated from activity instance IDs 4, 5, 6, and 7 (424, 425, 426, and 427), and group instance ID 3 (514) being generated from activity instance IDs 7, 8, 9, and 10 (427, 428, 429, and 430).

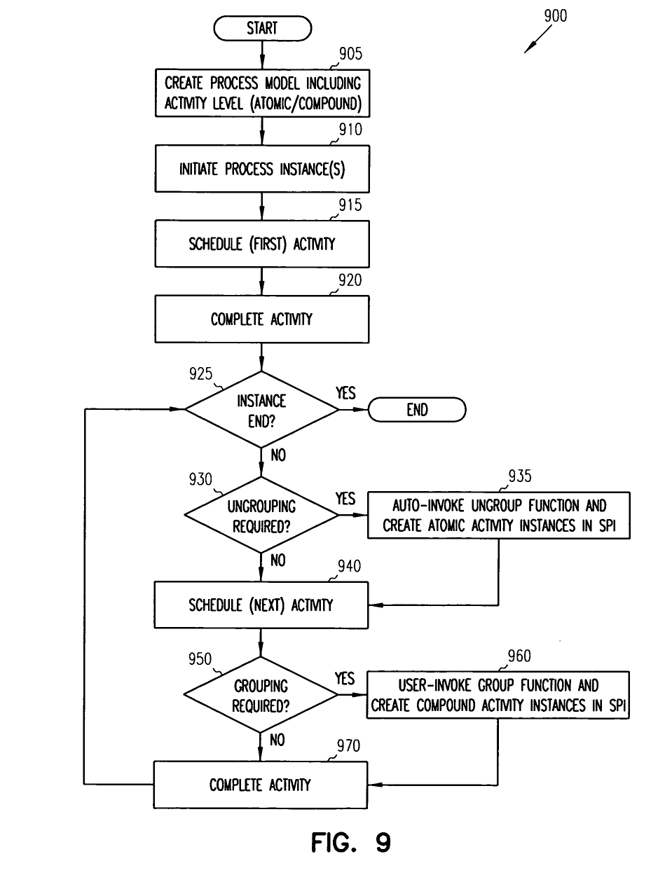

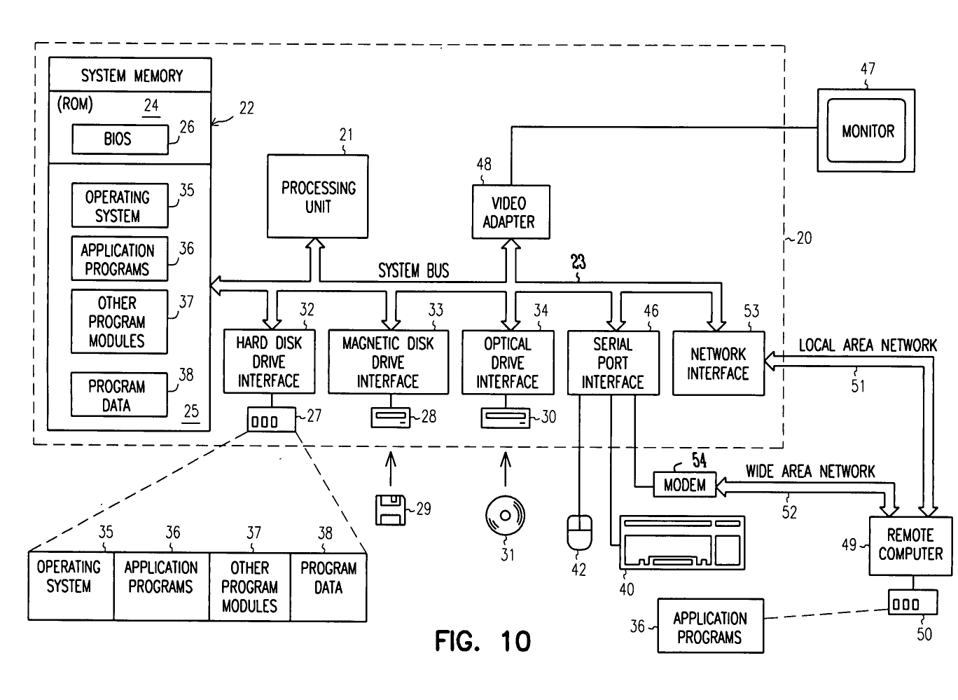

The grouped activities 510, 512, and 514 eventually reach the “Complete” state as illustrated in FIG. 6 (activity state S (FIG. 2, No. 230) equals “C”). When the grouped activities reach the “Complete” state, the states of all the atomic activities associated with the grouped activities are simultaneously changed to “Complete.” FIG. 7. In an embodiment, the Control Data process 130 records for each activity ID the group to which the activity belongs (e.g., No. 421's group ID is 1 since it was generated by No. 510 whose group ID is 1). The process then continues, and the next activity is made available (in this example, activity ID C) for grouping, ungrouping and regrouping. See FIG. 8. A general process flow is illustrated in FIG. 9. In the process 900 of FIG. 9, a process model is created (905). The creation of the process model includes defining whether the activity level is atomic or compound. A process instance is initiated (910), and a first activity is scheduled (915) and thereafter completed (920). If the process has not yet completed (925), and ungrouping is required (930), the ungroup function is invoked, atomic activity instances are created (935), and the next activity is scheduled (940). Then, if grouping is required (950), the grouping function is invoked and compound activity instances are created (960). The activity is then completed (970), and if there are more instances (925), the ungrouping and grouping functions may be invoked again (930, 935, 940, 950, 960).

FIG. 10 is an overview diagram of a hardware and operating environment in conjunction with which embodiments of the invention may be practiced. The description of FIG. 10 is intended to provide a brief, general description of suitable computer hardware and a suitable computing environment in conjunction with which the invention may be implemented. In some embodiments, the invention is described in the general context of computer-executable instructions, such as program modules, being executed by a computer, such as a personal computer. Generally, program modules include routines, programs, objects, components, data structures, etc., that perform particular tasks or implement particular abstract data types.

Moreover, those skilled in the art will appreciate that the invention may be practiced with other computer system configurations, including hand-held devices, multiprocessor systems, microprocessor-based or programmable consumer electronics, network PCS, minicomputers, mainframe computers, and the like. The invention may also be practiced in distributed computer environments where tasks are performed by I/O remote processing devices that are linked through a communications network. In a distributed computing environment, program modules may be located in both local and remote memory storage devices.

In the embodiment shown in FIG. 10, a hardware and operating environment is provided that is applicable to any of the servers and/or remote clients shown in the other Figures.

As shown in FIG. 10, one embodiment of the hardware and operating environment includes a general purpose computing device in the form of a computer 20 (e.g., a personal computer, workstation, or server), including one or more processing units 21, a system memory 22, and a system bus 23 that operatively couples various system components including the system memory 22 to the processing unit 21. There may be only one or there may be more than one processing unit 21, such that the processor of computer 20 comprises a single central-processing unit (CPU), or a plurality of processing units, commonly referred to as a multiprocessor or parallel-processor environment. In various embodiments, computer 20 is a conventional computer, a distributed computer, or any other type of computer.

The system bus 23 can be any of several types of bus structures including a memory bus or memory controller, a peripheral bus, and a local bus using any of a variety of bus architectures. The system memory can also be referred to as simply the memory, and, in some embodiments, includes read-only memory (ROM) 24 and random-access memory (RAM) 25. A basic input/output system (BIOS) program 26, containing the basic routines that help to transfer information between elements within the computer 20, such as during start-up, may be stored in ROM 24. The computer 20 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM or other optical media.

The hard disk drive 27, magnetic disk drive 28, and optical disk drive 30 couple with a hard disk drive interface 32, a magnetic disk drive interface 33, and an optical disk drive interface 34, respectively. The drives and their associated computer-readable media provide non volatile storage of computer-readable instructions, data structures, program modules and other data for the computer 20. It should be appreciated by those skilled in the art that any type of computer-readable media which can store data that is accessible by a computer, such as magnetic cassettes, flash memory cards, digital video disks, Bernoulli cartridges, random access memories (RAMs), read only memories (ROMs), redundant arrays of independent disks (e.g., RAID storage devices) and the like, can be used in the exemplary operating environment.

A plurality of program modules can be stored on the hard disk, magnetic disk 29, optical disk 31, ROM 24, or RAM 25, including an operating system 35, one or more application programs 36, other program modules 37, and program data 38. A plug in containing a security transmission engine for the present invention can be resident on any one or number of these computer-readable media.

A user may enter commands and information into computer 20 through input devices such as a keyboard 40 and pointing device 42. Other input devices (not shown) can include a microphone, joystick, game pad, satellite dish, scanner, or the like. These other input devices are often connected to the processing unit 21 through a serial port interface 46 that is coupled to the system bus 23, but can be connected by other interfaces, such as a parallel port, game port, or a universal serial bus (USB). A monitor 47 or other type of display device can also be connected to the system bus 23 via an interface, such as a video adapter 48. The monitor 40 can display a graphical user interface for the user. In addition to the monitor 40, computers typically include other peripheral output devices (not shown), such as speakers and printers.

The computer 20 may operate in a networked environment using logical connections to one or more remote computers or servers, such as remote computer 49. These logical connections are achieved by a communication device coupled to or a part of the computer 20; the invention is not limited to a particular type of communications device. The remote computer 49 can be another computer, a server, a router, a network PC, a client, a peer device or other common network node, and typically includes many or all of the elements described above I/O relative to the computer 20, although only a memory storage device 50 has been illustrated. The logical connections depicted in FIG. 10 include a local area network (LAN) 51 and/or a wide area network (WAN) 52. Such networking environments are commonplace in office networks, enterprise-wide computer networks, intranets and the internet, which are all types of networks.

When used in a LAN-networking environment, the computer 20 is connected to the LAN 51 through a network interface or adapter 53, which is one type of communications device. In some embodiments, when used in a WAN-networking environment, the computer 20 typically includes a modem 54 (another type of communications device) or any other type of communications device, e.g., a wireless transceiver, for establishing communications over the wide-area network 52, such as the internet. The modem 54, which may be internal or external, is connected to the system bus 23 via the serial port interface 46. In a networked environment, program modules depicted relative to the computer 20 can be stored in the remote memory storage device 50 of remote computer, or server 49. It is appreciated that the network connections shown are exemplary and other means of, and communications devices for, establishing a communications link between the computers may be used including hybrid fiber-coax connections, T1-T3 lines, DSL's, OC-3 and/or OC-12, TCP/IP, microwave, wireless application protocol, and any other electronic media through any suitable switches, routers, outlets and power lines, as the same are known and understood by one of ordinary skill in the art.

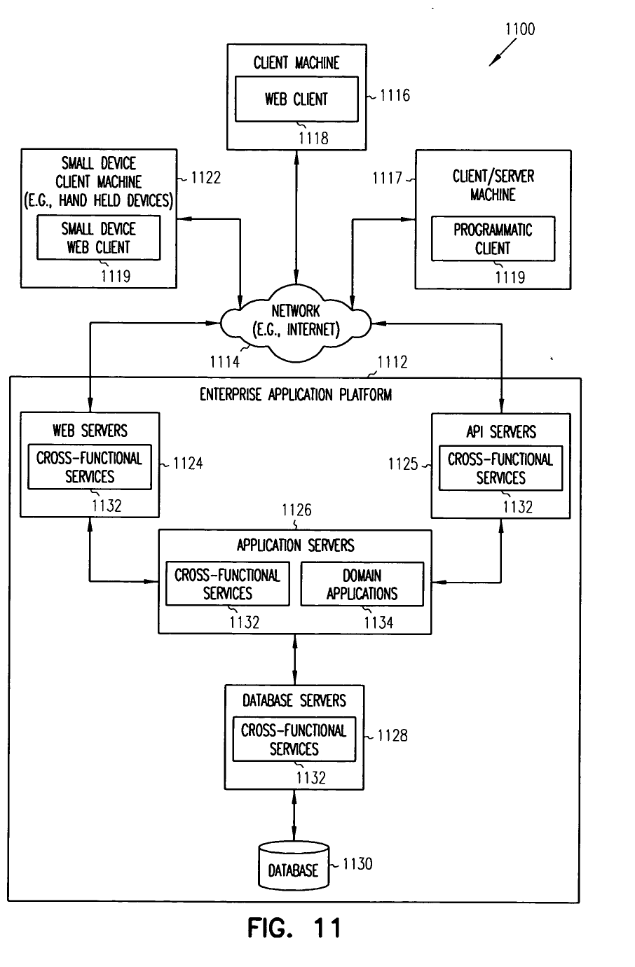

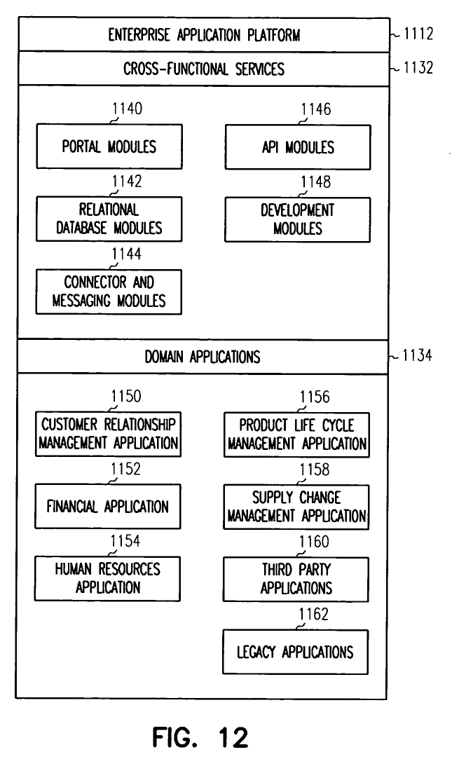

FIG. 11 illustrates another example of a network system 1100, having a client server architecture, that an exemplary embodiment disclosed herein can operate on and in connection with. A platform (e.g., machines and software), in the exemplary form of an enterprise application platform 1112, provides server-side functionality, via a network 1114 (e.g., the Internet) to one or more clients. FIG. 11 illustrates, for example, a client machine 1116 with web client 1118 (e.g., a browser, such as the INTERNET EXPLORER browser developed by Microsoft Corporation of Redmond, Wash. State), a small device client machine 1122 with a small device web client 1119 (e.g., a browser without a script engine) and a client/server machine 1117 with a programmatic client 1119.

Turning specifically to the enterprise application platform 1112, web servers 1124, and Application Program Interface (API) servers 1125 are coupled to, and provide web and programmatic interfaces to, application servers 1126. The application servers 1126 are, in turn, shown to be coupled to one or more databases servers 1128 that facilitate access to one or more databases 1130. The web servers 1124, Application Program Interface (API) servers 1125, application servers 1126, and database servers 1128 host cross-functional services 1132. The application servers 1126 further host domain applications 1134.

The cross-functional services 1132 provide services to users and processes that utilize the information enterprise application platform 1112. For instance, the cross-functional services 1132 provide portal services (e.g., web services), database services and connectivity to the domain applications 1134 for users that operate the client machine 1116, the client/server machine 1117 and the small device client machine 1122. In addition, the cross-functional services 1132 provide an environment for delivering enhancements to existing applications and for integrating third party and legacy applications with existing cross-functional services 1132 and domain applications 1134. Further, while the system 1100 shown in FIG. 11 employs a client-server architecture, the present invention is of course not limited to such an architecture, and could equally well find application in a distributed, or peer-to-peer, architecture system.

FIG. 12 is a block diagram illustrating enterprise applications and services as embodied in the enterprise application platform 1112, within which an exemplary embodiment of the present invention may be deployed. The enterprise application platform 1112 includes cross-functional services 1132 and domain applications 1134. The cross-functional services 1132 include portal modules 1140, relational database modules 1142, connector and messaging modules 1144, Application Program Interface (API) modules 1146, and development modules 1148.

The portal modules 1140 enable a single point of access to other cross-functional services 1132 and domain applications 1134 for the client machine 1116, the small device client machine 1122 and the client/server machine 1117. The portal modules 1140 are utilized to process, author and maintain web pages that present content (e.g., user interface elements and navigational controls) to the user. In addition, the portal modules 1140 enable user roles, a construct that associates a role with a specialized environment that is utilized by a user to execute tasks, utilize services and exchange information with other users and within a defined scope. For example, the role determines the content that is available to the user and the activities that the user may perform. The portal modules 1140 include a generation module, a communication module, a receiving module and a regenerating module. In addition, the portal modules 1140 comply with web services standards and/or utilize a variety of Internet technologies including Java, J2EE, SAP's Advanced Business Application Programming Language (ABAP) and Web Dynpro, XML, JCA, JAAS, X.509, LDAP, WSDL, WSRR, SOAP, UDDI and Microsoft.NET.

The relational database modules 1142 provide support services for access to the database 1130 that includes a user interface library. The relational database modules 1142 provide support for object relational mapping, database independence and distributed computing. The relational database modules 1142 are utilized to add, delete, update and manage database elements. In addition, the relational database modules 1142 comply with database standards and/or utilize a variety of database technologies including SQL, SQLDBC, Oracle, MySQL, Unicode, JDBC.

The connector and messaging modules 1144 enable communication across different types of messaging systems that are utilized by the cross-functional services 1132 and the domain applications 1134 by providing a common messaging application processing interface. The connector and messaging modules 1144 enable asynchronous communication on the enterprise application platform 1112.

The Application Platform Interface (API) modules 1146 enable the development of service-based applications by exposing an interface to existing and new applications as services. Repositories are included in the platform as a central place to find available services when building applications.

The development modules 1148 provide a development environment for the addition, integration, updating and extension of software components on the enterprise application platform 1112 without impacting existing cross-functional services 1132 and domain applications 1134.

Turning to the domain applications 1134, the customer relationship management applications 1150 enable access to and facilitates collecting and storing of relevant personalized information from multiple data sources and business processes. Enterprise personnel that are tasked with developing a buyer into a long-term customer may utilize the customer relationship management applications 1150 to provide assistance to the buyer throughout a customer engagement cycle.

Enterprise personnel may utilize the financial applications 1152 and business processes to track and control financial transactions within the enterprise application platform 1112. The financial applications 1152 facilitate the execution of operational, analytical and collaborative tasks that are associated with financial management. Specifically, the financial applications 1152 enable the performance of tasks related to financial accountability, planning forecasting, and managing the cost of finance.

The human resource applications 1154 may be utilized by enterprise personal and business processes to manage, deploy, and track enterprise personnel. Specifically, the human resource applications 1154 enable the analysis of human resource issues and facilitate human resource decisions based on real time information.

The product life cycle management applications 1156 enable the management of a product throughout the life cycle of the product. For example, the product life cycle management applications 1156 enable collaborative engineering, custom product development, project management, asset management and quality management among business partners.

The supply chain management applications 1158 enable monitoring of performances that are observed in supply chains. The supply chain management applications 158 facilitate adherence to production plans and on-time delivery of products and services.

The third party applications 1160, as well as legacy applications 1162, may be integrated with domain applications 1134 and utilize cross-functional services 1132 on the enterprise application platform 1112.

In the foregoing detailed description of embodiments of the invention, various features are grouped together in a single embodiment for the purpose of streamlining the disclosure. This method of disclosure is not to be interpreted as reflecting an intention that the claimed embodiments of the invention require more features than are expressly recited in each claim. Rather, as the following claims reflect, inventive subject matter lies in less than all features of a single disclosed embodiment. Thus the following claims are hereby incorporated into the detailed description of embodiments of the invention, with each claim standing on its own as a separate embodiment. It is understood that the above description is intended to be illustrative, and not restrictive. It is intended to cover all alternatives, modifications and equivalents as may be included within the spirit and scope of the invention as defined in the appended claims. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein,” respectively. Moreover, the terms “first,” “second,” and “third,” etc., are used merely as labels, and are not intended to impose numerical requirements on their objects.

1. A workflow process management system including:
a process;
said process including one or more activities;
said process further including one or more primary process instances; and
said one or more primary process instances including one or more alternative process instances, the alternative process instances being available to be grouped by the workflow process management system differently from a grouping of the one or more primary process instances.

2. The workflow process management system of claim 1, wherein said one or more alternative process instances include:
a first activity ID;
a first set of process instance IDs;
a first set of activity instance IDs; and
a first activity state.

3. The workflow process management system of claim 2, wherein said one or more alternative process instances include a second set of activity instance IDs, a second activity ID, and a second activity state.

4. The workflow process management system of claim 3, wherein said one or more alternative process instances including said second activity ID further include a third set of activity instance IDs.

5. The workflow process management system of claim 4, wherein said one or more alternative process instances further include a first set of group instance IDs.

6. The workflow process management system of claim 5, wherein said one or more alternative process instances including said first set of group instance IDs further include a fourth set of activity instance IDs and a fifth set of activity instance IDs.

7. The workflow process management system of claim 6, wherein said one or more alternative process instances further include a third activity ID.

8. A workflow process management system including:
a process;
the process including one or more activities;
the process further including one or more primary process instances; and
the more or more primary process instances including one or more alternative process instances, the alternative process instances being available to be grouped by the workflow process management system differently from a grouping of the one or more primary process instances;
wherein the one or more alternative process instances include:
an activity ID;
a process instance ID;
an activity instance ID;
a group instance ID; and
an activity state ID.

9. The workflow process management system of claim 8, wherein the one or more alternative process instances further include:
a first activity ID;
a first set of process instance IDs;
a first set of activity instance IDs; and
a first activity state.

10. The workflow process management system of claim 9, wherein the one or more alternative process instances further include a second set of activity instance IDs, a second activity ID, a third set of activity instance IDs, and a second activity state.

11. The workflow process management system of claim 10, wherein the one or more alternative process instances further include:
a first group instance ID;
a fourth set of activity instance IDs; and
a second set of process instance IDs.

12. The workflow process management system of claim 11, further including a third activity state, a third set of process instance IDs, and a third activity ID.

13. A workflow management process including:
generating a first set of one or more activities, the activities of the first set including:
a first activity ID;
a first set of process instance IDs;
a first set of activity instance IDs; and
a first activity state;
ungrouping the first set of one or more activities, thereby creating a second set of one or more activities, the activities of the second set including:
a second set of activity instance IDs;
generating a third set of one or more activities, the activities of the third set including:
a second activity ID;
a second activity state; and
a second set of activity instance IDs; and
regrouping the third set of one or more activities, thereby creating a fourth set of one or more activities, the activities of the fourth set including:
a first group instance ID; and
a third set of activity instance IDs.

14. The workflow management process of claim 13, further including:
ungrouping the fourth set of one or more activities, thereby creating a fifth set of one or more activities, the activities of the fifth set including:
a second set of process instance IDs; and
a fourth set of activity instance IDs.

15. The workflow management process of claim 14, further including generating a sixth set of one or more activities, the activities of the sixth set including:
a third activity ID; and
a third activity state.

16. A machine-readable medium including instructions to cause a machine to perform a process including:
generating a first set of one or more activities, the activities of the first set including:
a first activity ID;
a first set of process instance IDs;
a first set of activity instance IDs; and
a first activity state;
ungrouping the first set of one or more activities, thereby creating a second set of one or more activities, the activities of the second set including:
a second set of activity instance IDs;
generating a third set of one or more activities, the activities of the third set including:
a second activity ID;
a second activity state; and
a second set of activity instance IDs; and
regrouping the third set of one or more activities, thereby creating a fourth set of one or more activities, the activities of the fourth set including:
a first group instance ID; and
a third set of activity instance IDs.

17. The machine readable medium of claim 16, further including instructions for:
ungrouping the fourth set of one or more activities, thereby creating a fifth set of one or more activities, the activities of the fifth set including:
a second set of process instance IDs; and
a fourth set of activity instance IDs.

18. The machine readable medium of claim 17, further including instructions for generating a sixth set of one or more activities, the activities of the sixth set including:
a third activity ID; and
a third activity state.

19. A computer including:
a process;
the process including one or more activities;
the process further including one or more primary process instances; and
the more or more primary process instances including one or more alternative process instances, the alternative process instances being available to be grouped differently from a grouping of the one or more primary process instances;
wherein the one or more alternative process instances include:
an activity ID;
a process instance ID;
an activity instance ID;
a group instance ID; and
an activity state ID.

20. The computer of claim 19, wherein the one or more alternative process instances further include:
a first activity ID;
a first set of process instance IDs;
a first set of activity instance IDs; and
a first activity state.

21. The computer of claim 20, wherein the one or more alternative process instances further include a second set of activity instance IDs, a second activity ID, and a second activity state.

22. The computer of claim 21, wherein the one or more alternative process instances further include:
a first group instance ID;
a third set of activity instance IDs; and
a second set of process instance IDs.

23. The computer of claim 22, wherein the one or more alternative process instances including said second activity ID further include a third set of process instance IDs and a third activity ID.

24. A data structure for a workflow management system, the workflow management system including a worklist handler process and a workflow control data process, the data structure including:
activities;
primary process instances; and
alternative process instances;
wherein the primary process instances are a subset of the activities; and
wherein the alternative process instances are a subset of the primary process instances.

25. The data structure of claim 24, wherein the alternative process instances include:
an activity ID;
a process instance ID;
an activity instance ID;
an activity state; and
a group instance ID.

26. A process including:
creating a process model, the process model including an activity level definition;
initiating a process instance;
scheduling an activity;
invoking an ungroup function, the ungroup function creating an atomic activity; and
invoking a grouping function, the grouping function creating a compound activity.
